(19) United States
(12) Patent Application Publication
(10) Pub. No.: US 2010/0071995 A1
(43) Pub. Date: Mar. 25, 2010

(54) WIND TURBINE TOWER BASE ACCESS LADDER

(76) Inventors: Wayne S. Campbell, JR., Cleburne, TX (US); Todd Messina, Winnfield, LA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/236,760

(22) Filed: Sep. 24, 2008

(51) Int. Cl. E06C 7/16; E04B 1/00

(52) U.S. Cl. 182/115; 52/745.17

(57) ABSTRACT

A wind turbine tower base access ladder includes a ladder top having a first lip engaging structure disposed at a first end of the ladder top for engaging at least a portion of an outer lip of an opening of a wind turbine tower base when the ladder top is disposed to at least partially extend in the opening. The access ladder also includes a first ladder section attached at the first end of the ladder top and a second ladder section attached at a second end. The first ladder section and second ladder section extend downwardly from the ladder top on opposite sides of the wind turbine tower base when the ladder top is at least partially disposed in the opening effective for allowing a user to move between an exterior of the wind turbine tower base and interior of the wind turbine tower base via the opening.

### FIELD OF THE INVENTION

The present invention relates to wind turbines, and more particularly, to a ladder for accessing a wind turbine tower base having a lipped opening disposed above a foundation of the tower base.

### BACKGROUND OF THE INVENTION

Building structures, such as a wind turbine tower, may include access openings to provide users access to an interior portion of a tower base. Typically, such an opening may be disposed several feet above a foundation of the tower base. Although a permanent stairway access may be added to the structure upon completion of erection of the tower, means to safely access the interior of the tower base needs to be provided during erection.

### BRIEF DESCRIPTION OF THE DRAWINGS

The invention is explained in the following description in view of the drawings that show:

FIG. 1 is a partial schematic view of a wind turbine tower base having an access ladder disposed through a lipped opening of a tower base;

FIG. 2 is a perspective view of another embodiment of the access ladder;

FIG. 3 is partial perspective view seen from an exterior of the wind turbine tower base showing the access ladder of FIG. 2 disposed through the lipped opening; and

FIG. 4 is partial perspective view seen from an interior of the wind turbine tower base showing the access ladder of FIG. 2 disposed through the lipped opening.

### DETAILED DESCRIPTION OF THE INVENTION

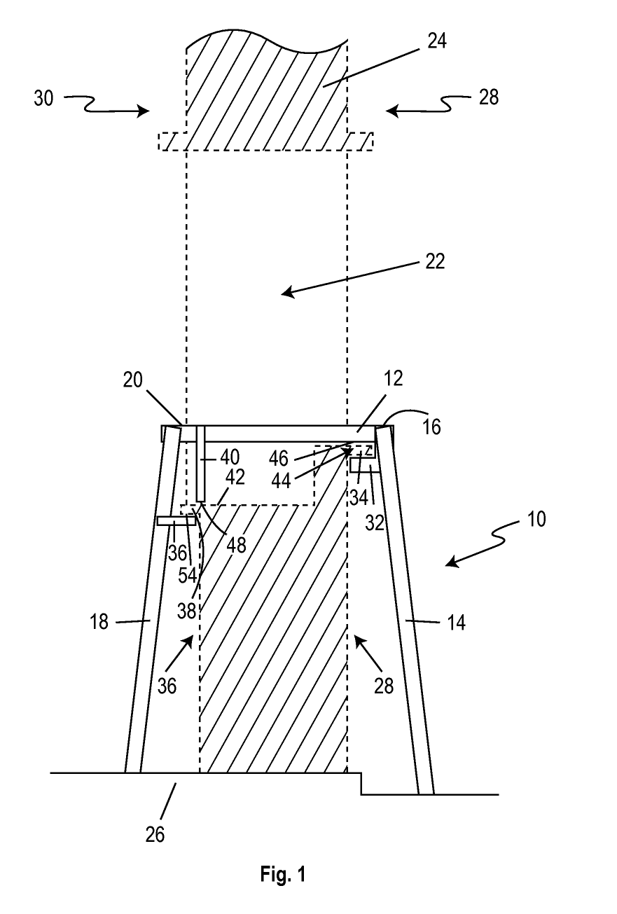

In an example embodiment of the invention shown in FIG. 1, an access ladder 10 for a wind turbine tower base 24 includes a ladder top 12, a first ladder section 14 attached a first end 16 of the ladder top 12, and a second ladder section 18 attached at a second end 20 of the ladder top 12. The first ladder section 14 and second ladder section 18 may extend downwardly from the ladder top 12, for example, in a stepladder-like fashion. In another example embodiment, the first ladder section 14 and/or the second ladder section 18 may be movably attached to the first end 16 and second end 20, respectively, of the ladder top 12, such as by a hinged connection for allowing the first ladder section 14 and/or the second ladder section 18 to rotate about the first end 16 and second end 20, respectively.

The access ladder 10 may be configured to be disposed through an opening 22 of the wind turbine tower base 24 that is elevated above a foundation 26 of the wind turbine tower base 24 to allow a user to easily move between an exterior 28 of the wind turbine tower base 24 and interior 30 of the wind turbine tower base 24 via the opening 22. For example, the first ladder section 14 and the second ladder section 18 extend downwardly from the ladder top 12 on opposite sides of the wind turbine tower base 24 when the ladder top is at least partially disposed in the opening 22. The access ladder 10 may be formed from any suitable ladder construction materials such as wood, metal, and/or fiberglass. In an aspect of the invention ladder top may include slip resistant surface, such as a grating for limiting buildup of foreign material on the ladder top 12.

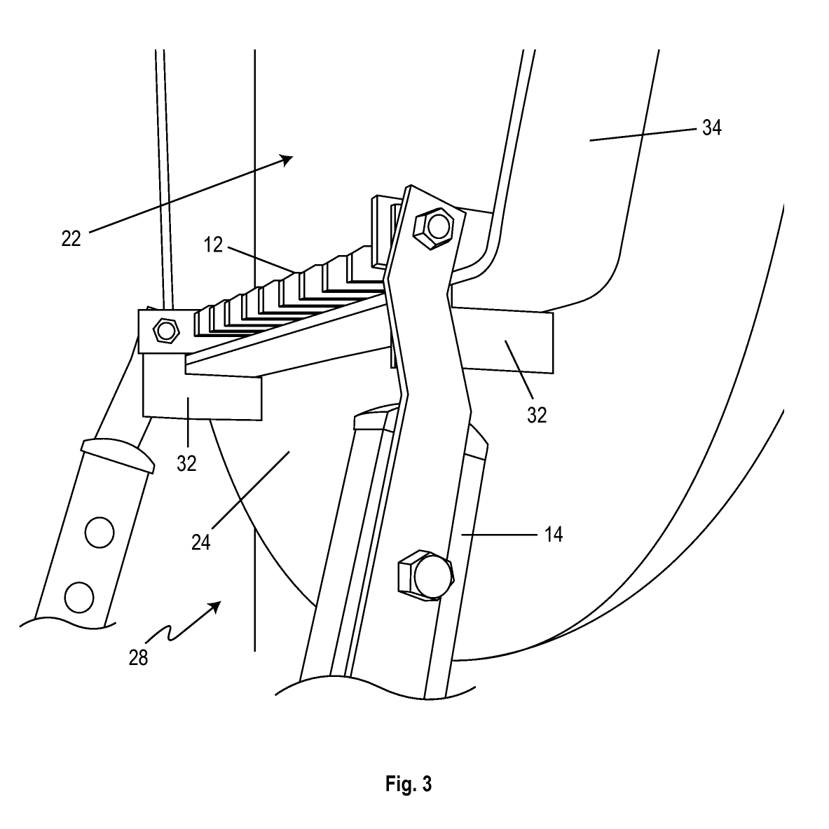

In an aspect of the invention depicted in FIGS. 1 and 3, the ladder top 12 may include a first lip engaging structure 32 disposed at the first end 16 of the ladder top 12 for engaging an outer lip 34 at the opening 22 of the wind turbine tower base 24 when the ladder top 12 is disposed to at least partially extend in the opening 22. For example, the lip engaging structure 32 may include a substantially “L” shaped bracket that forms a slot 44 in conjunction with an underside portion 46 of the ladder top 12. The slot 44 may be sized to receive at least a portion of the outer lip 34 therein and aligns and holds the access ladder 10 in place at an exterior 28 or the wind turbine tower base 24, yet remains easily removable when necessary. One or more first lip engaging structures 32 may be provided as desired. The arrangement of the engaging structure 32 may be configured to allow the ladder top 12 to be horizontally slid into engagement with the outer lip 34 to limit movement of the access ladder 12 when installed in the opening 22.

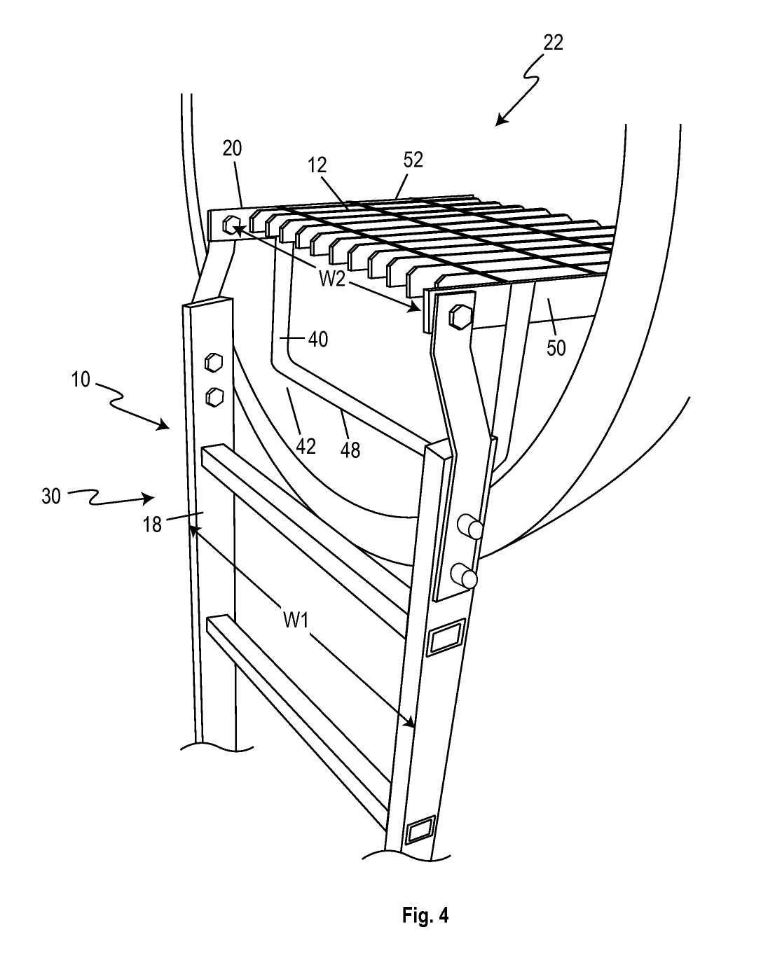

In an aspect of the invention depicted in FIGS. 1 and 4, the access ladder 10 may include a standoff member 40 downwardly extending from the ladder top 12 proximate the second end 20 for supporting the ladder top 20 in a substantially horizontal position against an inner portion 42 of the opening 22. For example, the standoff member 40 may include a substantially “U” shaped bracket having ends attached to respective sides 50, 52 of the ladder top 12, wherein at least a portion of the bottom 48 of the “U” rests against the inner portion 42 that may be formed in a shelf configuration.

In yet another aspect of the invention shown in FIG. 1, the access ladder 10 may include a spacer 36 attached to the second ladder section 18 for spacing the second ladder 18 away from the inner lip 38 and/or the wind turbine tower base 24. The spacer 36 may be configured for ensuring that there is sufficient foot clearance between the inner lip 38 and/or the wind turbine tower base for allowing a user to safely climb and descend the second ladder 18. For example, as can be seen in FIG. 1, the spacer 36 may include a rectangular element extending inwardly away from the second ladder section 18 for resting against the tower base 24 below the inner lip 38 when the access ladder 10 is positioned in the opening for allowing a user to access an interior 30 of the wind turbine tower base 24. One or more spacers 36 may be provided as desired. In another example embodiment, the spacer 36 may be configured as a second lip engaging structure for engaging an inner lip 38 of the opening 22. For example, when configured as a second lip engaging structure, the spacer 36 may include a rectangular element extending inwardly away from the second ladder section 18 so as to engage a bottom 54 of the inner lip 38. In an aspect of the invention, the second ladder section 18 may be rotated about the second end 20 in a counterclockwise direction relative to the position shown in FIG. 1 when installing the access ladder 10 and then rotated back in a clockwise direction to rest against the tower base 24 below the inner lip 38 and/or engage the inner lip 38.

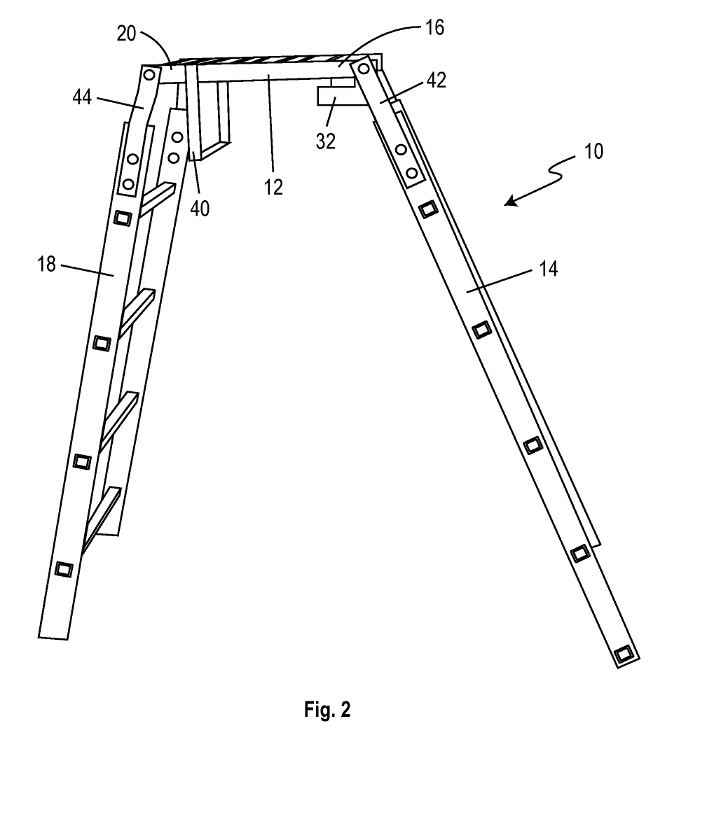

In another aspect of the invention shown in FIGS. 2-4, the access ladder 10 may include first ladder section 14 and/or second ladder section 18 that are formed form at least portions of prefabricated ladders, such as commercially available extension ladder sections. First ladder section 14 and/or second ladder section 18 may be attached to the respective ends of the ladder top 12 with respective adapter members 42, 44. As can be seen in FIG. 4, the members 42, 44 may be configured to adapt a width W1 of the first ladder section 14 and/or second ladder section 18 to a width W2 of the ladder top 12.

In another aspect of the invention, a method for erecting a wind turbine tower using a base access ladder as described above may include constructing a foundation, attaching a wind turbine tower base 24 to the foundation, installing an access ladder 10 via an opening 22 in the tower base 24 for temporarily accessing an interior 30 of the tower base 24 during construction, erecting a wind turbine tower on the tower base 24, and installing a wind turbine atop the tower.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A wind turbine tower base access ladder comprising:
a ladder top comprising a first lip engaging structure disposed at a first end of the ladder top for engaging at least a portion of an outer lip of an opening of a wind turbine tower base when the ladder top is disposed to at least partially extend in the opening;
a first ladder section attached at the first end of the ladder top; and
a second ladder section attached at a second end of the ladder top so that the first ladder section and second ladder section extend downwardly from the ladder top on opposite sides of the wind turbine tower base when the ladder top is at least partially disposed in the opening effective for allowing a user to move between an exterior of the wind turbine tower base and interior of the wind turbine tower base via the opening.

2. The wind turbine tower base access ladder of claim 1, wherein the first lip engaging structure comprises a substantially “L” shaped bracket that forms a slot in conjunction with an underside portion of the ladder top at the first end.

3. The wind turbine tower base access ladder of claim 1, further comprising a standoff member downwardly extending from the ladder top proximate the second end for supporting the ladder top in a substantially horizontal position against an inner portion of the opening at an interior of the wind turbine tower base.

4. The wind turbine tower base access ladder of claim 3, wherein the standoff member comprises a substantially “U” shaped bracket having ends attached to respective sides of the ladder top, wherein at least a portion of the bottom of the “U” is configured for resting against the inner portion.

5. The wind turbine tower base access ladder of claim 1, further comprising a spacer attached to the second ladder section for spacing the second ladder away from the wind turbine tower base.

6. The wind turbine tower base access ladder of claim 5, wherein the spacer comprises a rectangular element extending inwardly away from the second ladder section for resting against the tower base below the inner lip.

7. The wind turbine tower base access ladder of claim 1, further comprising a second lip engaging structure attached to the second ladder section for engaging an inner lip of the opening.

8. The wind turbine tower base access ladder of claim 7, wherein the second lip engaging structure comprises a rectangular element extending inwardly away from the second ladder section for engaging a bottom portion of the inner lip.

9. The wind turbine tower base access ladder of claim 1, wherein the first ladder section is movably attached to the first end of the ladder top.

10. The wind turbine tower base access ladder of claim 1, wherein the first ladder section is configured to rotate about the first end of the ladder top.

11. The wind turbine tower base access ladder of claim 1, wherein the second ladder section is movably attached to the second end of the ladder top.

12. The wind turbine tower base access ladder of claim 1, wherein the second ladder section is configured to rotate about the second end of the ladder top.

13. The wind turbine tower base access ladder of claim 1, wherein the first ladder section is attached to the first end of the ladder top with an adapter member.

14. The wind turbine tower base access ladder of claim 1, wherein the second ladder section is attached to the second end of the ladder top with an adapter member.

15. A wind turbine tower base comprising:
an opening disposed above a foundation of the wind turbine tower base comprising a lip extending substantially horizontally outwardly therefrom;
an access ladder comprising:
a ladder top having a lip engaging structure disposed at a first end of the ladder top for engaging at least a portion of the lip when the ladder top is disposed to at least partially extend in the opening;
a first ladder section attached at the first end of the ladder top; and
a second ladder section attached at a second end of the ladder top so that the first ladder section and second ladder section extend downwardly from the ladder top on opposite sides of the wind turbine tower base when the ladder top is at least partially disposed in the opening effective for allowing a user to move between an exterior of the wind turbine tower base and interior of the wind turbine tower base via the opening.

16. The wind turbine tower base of claim 15, wherein the substantially “L” shaped bracket forms a slot in conjunction with an underside portion of the ladder top at the first end for receiving the at least portion of the lip therein.

17. The wind turbine tower base of claim 15, wherein the access ladder further comprises a standoff member downwardly extending from the ladder top proximate the second end for supporting the ladder top in a substantially horizontal position against an inner portion of the opening at an interior of the wind turbine tower base.

18. A wind turbine tower base access ladder comprising:
a ladder top comprising a substantially “L” shaped first lip engaging structure disposed at a first end of the ladder top for engaging at least a portion of an outer lip at an opening of a wind turbine tower base when the ladder top is disposed to at least partially extend through the opening;
a standoff member downwardly extending from the ladder top proximate a second end for supporting the ladder top in a substantially horizontal position against an inner portion of the opening at an interior of the wind turbine tower base;
a first ladder section attached at the first end of the ladder top;
a second ladder section attached at the second end of the ladder top so that the first ladder section and second ladder section extend downwardly from the ladder top on opposite sides of the wind turbine tower base when the ladder top is at least partially disposed in the opening effective to allow a user to move between an exterior of the wind turbine tower base and interior of the wind turbine tower base via the opening.

19. The wind turbine tower base access ladder of claim 18, wherein the substantially “L” shaped bracket forms a slot in conjunction with an underside portion of the ladder top at the first end for receiving the at least portion of the outer lip therein.

20. The wind turbine tower base access ladder of claim 18, wherein the standoff member comprises a substantially “U” shaped bracket having ends attached to respective sides of the ladder top, wherein at least a portion of the bottom of the “U” is configured for resting against the inner portion.

21. The wind turbine tower base access ladder of claim 18, further comprising a spacer attached to the second ladder section for engaging an inner lip of the opening.

22. A method for erecting a wind turbine tower using an access ladder comprising:
constructing a foundation;
attaching a wind turbine tower base to the foundation;
installing an access ladder via an opening in the tower base for temporarily accessing an interior of the tower base during construction, wherein the access ladder comprises a ladder top comprising a first lip engaging structure disposed at a first end of the ladder top for engaging at least a portion of an outer lip of an opening of a wind turbine tower base when the ladder top is disposed to at least partially extend in the opening, a first ladder section attached at the first end of the ladder top, and a second ladder section attached at a second end of the ladder top so that the first ladder section and second ladder section extend downwardly from the ladder top on opposite sides of the wind turbine tower base when the ladder top is at least partially disposed in the opening effective for allowing a user to move between an exterior of the wind turbine tower base and interior of the wind turbine tower base via the opening;
erecting a wind turbine tower on the tower base; and
installing a wind turbine on the tower.
